(19) United States
(12) Patent Application Publication
(10) Pub. No.: US 2014/0315166 A1
(43) Pub. Date: Oct. 23, 2014

(54) Portable device to manage and control air traffic control training system

(71) Applicant: Thales Australia Limited, Garden Island, New South Wales (AU)

(72) Inventors: Grant Williams, Bentleigh (AU); Mark James O'Flynn, Balwyn North (AU); Roland Huber, Melbourne (AU); Mark Palmer, Melbourne (AU)

(73) Assignee: Thales Australia Limited, Garden Island, New South Wales (AU)

(21) Appl. No.: 14/347,179

(22) PCT Filed: Jun. 5, 2012
(86) PCT No.: PCT/AU2012/000642

§ 371 Date: May 21, 2014

(30) Foreign Application Priority Data
Oct. 4, 2011 (AU) 2011904110

(51) Int. Cl. G09B 9/00

(52) U.S. Cl. CPC G09B 9/006
USPC 434/220

(57) ABSTRACT

A portable electronic device (810) for controlling a training exercise executing on a simulator of an Air Traffic Control (ATC) system, a method of doing the same using a portable electronic device (810), and a computer program product are disclosed. The device (810) is capable of wirelessly communicating with the simulator (820, 830) also suitable adapted for wireless communications. The device (810) comprises a display, a memory for storing data and one or more computer programs, a user input mechanism, and a processor. The device (810) displays on the display information about a training exercise executing on the simulator and receives inputs to control the training exercise on the simulator. The displayed information and the received inputs are communicated between the simulator and the portable electronic device (810).

### RELATED APPLICATION

The present application claims the benefit, in the U.S. under 35 U.S.C. §119, of the earlier filing date of Australian Provisional Application No. 2011904110 filed on 4 Oct. 2011 in the name of Thales Australia Limited, which is incorporated herein by reference in its entirety.

### TECHNICAL FIELD

The present invention relates generally to the field of Air Traffic Control (ATC) systems and more particularly to training systems and simulators for Air Traffic Control systems.

### BACKGROUND

Current ATC training systems (simulators) require a dedicated, fixed, position to control the state of a training exercise (i.e. paused, running, speed) and provide information about the training exercise (i.e. exercise time, active aircraft, pending aircraft and events). This position is usually in a room separate to the ATC trainee.

An ATC training instructor is sometimes required to stand adjacent to a trainee during a training exercise. When the instructor requires that the training exercise be paused, or the speed of the exercise changed, or information about aircraft in the training exercise, the instructor is required to communicate with the operator of the fixed exercise management position to make the desired change or provide the requested information. This can at times be inconvenient and cause changes to occur too late. Such activity could also alert the trainee about upcoming events in the training exercise that are supposed to be a surprise to the trainee.

During the execution of an ATC training exercise, an ATC instructor would, using current and previous solutions, communicate with the operator of the exercise management position verbally. This would usually be by utilising a dedicated channel on a voice switch, which requires the instructor to connect (plug in) a headset to the voice communications system at one of the ATC trainee positions.

The fact that the task of controlling the exercise is delegated to a separate operator results in a loss of fidelity in the control of the training exercise. Actions are not performed as efficiently as the actions could be.

### SUMMARY

In accordance with an aspect of the invention, there is provided a portable electronic device for controlling a training exercise executing on a simulator of an Air Traffic Control (ATC) system. The device comprises a wireless communications, a display, a memory, a user input mechanism for receiving inputs, and a processor. The wireless communications interface enables wireless communications with the simulator, also suitably adapted for wireless communications. The memory stores data and one or more computer programs. The processor is coupled to the memory, the user input mechanism, the display, and the wireless communications interface. The processor executes computer program code for displaying on the display information about a training exercise executing on the simulator and for receiving inputs to control the training exercise on the simulator. The displayed information and the received inputs are communicated between the simulator and the portable electronic device.

Preferably, the portable electronic device is implemented in a tablet computing device, where the display and the user input mechanism are implemented using a touchscreen.

The computer program executing on the processor may provide a Simulator Control Display displayed on the display, the Simulator Control Display comprising an Exercise Control Panel and a Pilot Tracks Panel.

The portable electronic device may further comprise computer program code executing on the processor to provide graphical objects displayed on the display for controlling operation of the training exercise on the simulator, including RUNNING, PAUSING, and STOPPING commands, in response to a user input received by the user input mechanism.

The portable electronic device may further comprise computer program code executing on the processor to provide a graphical object for displaying and adjusting the speed at which the training exercise is carried out on the simulator.

The portable electronic device may further comprise computer program code executing on the processor to provide pilot track strips displayed on the display, including aircraft information and flight plan information.

In accordance with another aspect of the invention, there is provided a method of controlling a training exercise executing on a simulator of an Air Traffic Control (ATC) system using a portable electronic device. The method comprises: displaying on a display of the portable electronic device information about a training exercise executing on the simulator; receiving inputs using the portable electronic device to control the training exercise on the simulator; and wirelessly communicating the displayed information and the received inputs between the simulator and the portable electronic device.

The portable electronic device may comprise a wireless communications interface for wirelessly communicating with the simulator adapted for wireless communications, a memory for storing data and one or more computer programs, a user input mechanism for receiving inputs, and a processor coupled to the memory, the user input mechanism, the display, and the wireless communications interface, the processor executing computer program code for displaying on the display information a training exercise executing on the simulator and for receiving inputs to control the training exercise on the simulator, the displayed information and the received inputs being communicated between the simulator and the portable electronic device.

Preferably, the portable electronic device comprises a tablet computing device, where the display and the user input mechanism are implemented using a touchscreen.

The method may comprise displaying a Simulator Control Display on the display, the Simulator Control Display comprising an Exercise Control Panel and a Pilot Tracks Panel.

The method may comprise providing graphical objects displayed on the display for controlling operation of the training exercise on the simulator, including RUNNING, PAUSING, and STOPPING commands, in response to a user input received by the user input mechanism.

The method may comprise providing a graphical object for displaying and adjusting the speed at which the training exercise is carried out on the simulator.

The method may comprise providing pilot track strips displayed on the display, including aircraft information and flight plan information.

In accordance with still another aspect of the invention, there is provided a computer program product comprising a computer readable medium having recorded thereon a computer program controlling using a portable electronic device a training exercise executing on a simulator of an Air Traffic Control (ATC) system using a portable electronic device. The computer program product comprises: computer program code for displaying on a display of the portable electronic device information about a training exercise executing on the simulator; computer program code for receiving inputs using the portable electronic device to control the training exercise on the simulator; and computer program code for wirelessly communicating the displayed information and the received inputs between the simulator and the portable electronic device.

In accordance with a further aspect of the invention, there is provided an air traffic control (ATC) training system, comprising: a simulator for performing a training exercise involving one or more simulated aircraft, the simulator adapted to receive from a trainee instructions for the training exercise, the simulator comprising a wireless communications interface adapted for wireless communications; and a portable electronic device, as set forth hereinbefore, for controlling a training exercise executing on a simulator of an Air Traffic Control system using a portable electronic device.

### BRIEF DESCRIPTION OF THE DRAWINGS

Embodiments of the invention are described hereinafter with reference to the drawings, in which:

FIG. 1 is screenshot of a simulator control display 100 comprising a number of panels on a portable computer tablet device to provide an ATC Training Instructor with direct control of a training exercise running on an ATC system;

FIG. 2 is an expanded view in isolation of the exercise control panel 110 in the simulator control display 100 of FIG. 1;

FIG. 3 is an expanded view in isolation of the exercise information panel 210 in the exercise control panel 110 of FIG. 2;

FIG. 4 is an expanded view in isolation of the exercise status panel 220 in the exercise control panel 110 of FIG. 2;

FIG. 5 is an expanded view in isolation of the exercise speed panel 230 in the exercise control panel 110 of FIG. 2;

FIG. 6 is an expanded view in isolation of the pilot tracks panel 120 in the simulator control display 100 of FIG. 1;

FIG. 7 is an expanded view in isolation of an aircraft strip panel 620 in the pilot tracks panel 120 of FIG. 6;

FIG. 8 is a system block diagram illustrating a portable electronic device to provide an ATC Training Instructor with direct control of a training exercise running on an ATC system;

FIG. 9 is a block diagram illustrating connection states of the portable computer tablet device of FIG. 8;

FIG. 10 is a flow diagram illustrating a process of managing a connection of the portable computer tablet device of FIG. 8;

FIG. 11 is a flow diagram illustrating a process of controlling a training exercise using the portable computer tablet device of FIG. 8 through the exchange of messages between the portable device and the attached simulation group in FIG. 8; and

FIG. 12 is a block diagram of a portable electronic device, such as a tablet computing device, to provide an ATC Training Instructor with direct control of a training exercise running on an ATC system.

### DETAILED DESCRIPTION

Methods using portable handheld devices and such devices themselves adapted for controlling a training exercise running on an ATC system are disclosed. In the following description, numerous specific details, including particular electronic portable devices, computer system configurations, wireless communications protocols, and the like are set forth. However, from this disclosure, it will be apparent to those skilled in the art that modifications and/or substitutions may be made without departing from the scope and spirit of the invention. In other circumstances, specific details may be omitted so as not to obscure the invention.

Where reference is made in any one or more of the accompanying drawings to steps and/or features, which have the same reference numerals, those steps and/or features have for the purposes of this description the same function(s) or operation(s), unless the contrary intention appears.

### Overview

The embodiments of the invention provide an ATC Training Instructor with a portable electronic device (preferably a tablet computing device) that connects wirelessly to the ATC Training System and offers information and control of the currently executing exercise. The embodiments of the invention allow the ATC Training Instructor to have direct control of the training exercise, as well as having detailed information regarding the content of the training exercise that is currently running, including upcoming events. This control capability and information is such that the instructor can carry the portable device with the instructor and access the control capability and information regardless of the instructor's location (i.e. in training room, standing adjacent to trainee, in control room, etc).

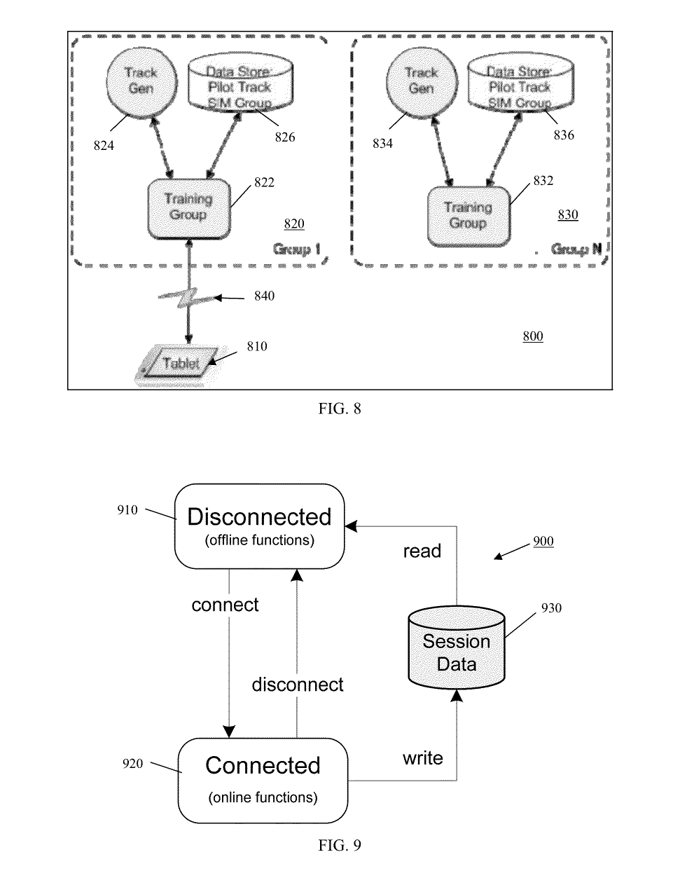

FIG. 8 illustrates a portable electronic device 810, preferably a portable tablet computing device, to provide an ATC Training Instructor with direct control of a training exercise running on an ATC system 800 having a simulator. The portable computer tablet device 810 can either be disconnected, or connected using wireless communications 840 (e.g., IEEE 802.11B/G/N) to one or more ATC simulation groups 820, 830. The system 800 may have 1 to N simulation groups 820, 830, where N is an integer. Each simulation group 820, 830 comprises a training group 822, 832, which can communicate with the controller tablet 810. In turn, the training group 822, 832 is coupled to a track generator 824, 834, which simulates the behaviour of all of the aircraft in the training exercise, and a data store 826, 836, which stores the status information about the current exercise being executed and information about each aircraft (pilot track) in the exercise, such as current state and planned behaviour. These components and their operation are described in greater detail hereinafter. The electronic device 810 comprises a wireless communications interface, a display (e.g. a touch screen), a memory, a user input mechanism for receiving operator inputs, and a processor. The processor is coupled to the memory, the user input mechanism, the display, and the wireless communications interface. The components are mounted in, on or part of a housing. The wireless communications interface allows wirelessly communications with the simulator adapted for wireless communications. The wireless communications may be implemented using a wireless LAN such as IEEE 802.11 B/G/N, Bluetooth™ technology, or any other wireless communications protocol suitable for communications between the device 810 and the simulator. The memory can store data and one or more computer programs. As described in detail hereinafter, the processor executes computer program code for displaying on the display about information a training exercise executing on the simulator and for receiving inputs to control the training exercise on the simulator. The displayed information and the received inputs are communicated between the simulator and the portable electronic device.

Where the portable electronic device 810 is implemented in a table computing device, the display and the user input mechanism can be implemented using a touchscreen. As described in greater detail hereinafter, the computer program executing on the processor can provide a Simulator Control Display displayed on the display. The Simulator Control Display may comprise an Exercise Control Panel and a Pilot Tracks Panel. The portable electronic device 810 may further comprise computer program code executing on the processor to provide graphical objects displayed on the display. The graphical objects (e.g. buttons, icons, or other suitable control mechanisms) control operation of the training exercise on the simulator in response to a user input received by the user input mechanism. Still further, the portable electronic device 810 may further comprise computer program code executing on the processor to provide a graphical object for displaying and adjusting the speed at which the training exercise is carried out on the simulator. The portable electronic device 810 may further comprise computer program code executing on the processor to provide pilot track strips displayed on the display, including aircraft information and flight plan information.

The portable tool 810 in accordance with embodiments of the invention allows an ATC Training Instructor to connect wirelessly to the ATC Training System and view the state of the training exercise being executed (i.e. exercise number, exercise time, paused, playing, speed, etc), view a list of the pending and active aircraft in this training exercise, and provide the ability to control this exercise through various interactions with the tool. This exercise control includes:
Play an exercise,
Pause and resume an exercise,
Stop an exercise, and
Exercise speed adjustment.

The use of such a portable tablet computing device provides an Air Traffic Control Training Instructor with direct control of a training exercise that is being executed by an ATC Training System and timely information regarding the status of the training exercise. For example, the embodiments of the invention may be implemented using an Apple iPad™ or a similar handheld wireless computing device capable of displaying information and receiving user inputs that can be transmitted to the ATC training simulator. An Android tablet or an Blackberry Playbook™ are examples of other portable electronic devices that may be programmed, e.g. with a controller app, that can be used to practice the invention. The timely information regarding the status of the training exercise includes, but is not limited to, exercise identification, exercise time, exercise run state (i.e. running, paused, speed) and simulated aircraft operating within the exercise.

The use of a portable device to control training exercises in accordance with one or more embodiments of the invention are expected to provide significant efficiency gains and resolve a number of issues related to exercise control that are caused by the configuration and physical layouts of certain ATC training systems. The portable device utilizes a display to allow the training instructor to visualize the information and accepts direct interaction though touch (i.e. taps, swipes, gestures, etc.) to allow the training instructor to change the state of the currently executing training exercise or view additional information relating to this training exercise.

### Air Traffic Control Systems and Training Systems

As used herein, Air traffic control (ATC) is a service provided by ground-based controllers who direct aircraft on the ground and in the air. Such Air Traffic Controllers utilise Air Traffic Control Systems to perform this activity, with the primary objectives being to:
Separate aircraft to prevent collision;
Expedite the flow of aircraft through the airspace that the Controllers are managing to minimise delays; and
Provide information and support to pilots as required.

Air Traffic Control systems receive data from multiple sources. This source data may include:
Flight plan information: this provides, as a minimum, details of an aircraft's identification (callsign), the type of aircraft, performance characteristics including equipment on board, arrival and destination airports, estimated time of departure and planned route to fly.
Surveillance data: this is traditionally provided by radars. However, more recently other systems such as ADS-B and Multi-lateration have been developed to also provide this information. The data usually includes an aircraft identifier, which could be callsign, a transponder code or other unique code, aircraft position, altitude, speed and heading.
Weather information: this could consist of wind direction and speed along with temperature at various levels and locations or radar data that shows areas of rain.

The Air Traffic Control system, when processing the source data, performs the following actions:
Association of received surveillance data with known flight plan information.
Predicting and highlighting any dangerous conditions, which can include a breakdown in separation (i.e. aircraft flying too close), aircraft entering restricted areas or aircraft flying too low.
Monitoring flights for conformance, which can include detecting if aircraft has deviated from the planned route defined in its associated flight plan, determining if aircraft is flying at an unauthorised altitude or if aircraft is late in reporting in.

An Air Traffic Controller has access to all of the above information through a graphical user interface. Traditionally, this is through an air situation display that offers a two-dimensional representation of the airspace that the air traffic controller is managing. Maps of the airspace being managed are overlayed with symbols representing the location of specific aircraft within this airspace. The air traffic controller can access information about the aircraft the air traffic controller is managing through separate windows that may be opened on the screen, over the air situation display, or through a data block, or tag, that is attached to the aircraft symbol.

Proper training of Air Traffic Controllers is critical. The systems that the controllers are using can be quite complex and the procedures rules and regulations that need to be followed are also complex. The initial training of an air traffic controller takes several years, with additional yearly training required throughout the rest of their career. In addition to training on all of the procedures and regulations, a trainee controller is also required to be trained on the use of the air traffic control system. This is done on an air traffic control training system.

An ATC training system is usually an air traffic control system that is identical to that used by the organisation training the controller to manage real aircraft, however instead of being connected to live external interfaces for flight plan and surveillance data the ATC system is connected to a simulator. The ATC simulator provides all of the data required for an ATC system to operate as the ATC system would normally (i.e. flight plans, radar feeds, weather information, etc.). Specific training scenarios are managed through training exercises. These training exercises specify the environment for a planned training scenario and define the aircraft that operate in this environment. Each aircraft in the exercise is scripted as to when the aircraft departs, the route the aircraft will fly and any interaction that is planned with the ATC system (i.e. reporting, transponder codes, etc.). ATC training instructors are able to create different exercises, with different scenarios, to provide training on specific actions, events or procedures to a trainee.

The operation of an ATC Training system is usually managed through a dedicated computer position. This management position allows the training supervisor to select a training exercise for execution, allocate the physical ATC controller positions for use during this exercise and control the operation of this exercise. This exercise control includes, as a minimum, starting the exercise, pausing the exercise to possibly discuss events with the trainee and setting the exercise execution speed. An exercise may need to operate at a faster speed than normal to get to a point in the exercise where a specific scenario is to occur, or may need to operate at a slower speed than normal to give a trainee time to respond and adequately cope with a particularly difficult scenario.

In addition to the exercise manager position a number of other positions are also included in an ATC Training system to allow for manual control of the simulated aircraft in the training exercises. These positions, sometimes referred to as Pilot Positions, allow an operator to act as a pilot for one or more aircraft in an executing training exercise. These “pilots” respond to clearances and commands given to them by the trainee air traffic controllers via a voice communications system that is similar to the operational system and, using the tools provided on the pilot position, direct the simulated aircraft to respond according to those clearances.

For simple training exercises a training instructor would normally allocate one to two pilot positions per ATC trainee. However for more complex exercises where a controller needs to be trained on high traffic density environments or specific events requiring significant manual control of aircraft, as many as five pilots per ATC trainee may need to be allocated. This makes the training air traffic controllers, not only a complex and time consuming activity, but also an extremely labour and resource intensive activity. A tool in accordance with an embodiment of the invention would improve the efficiency of ATC training.

### Portable Device

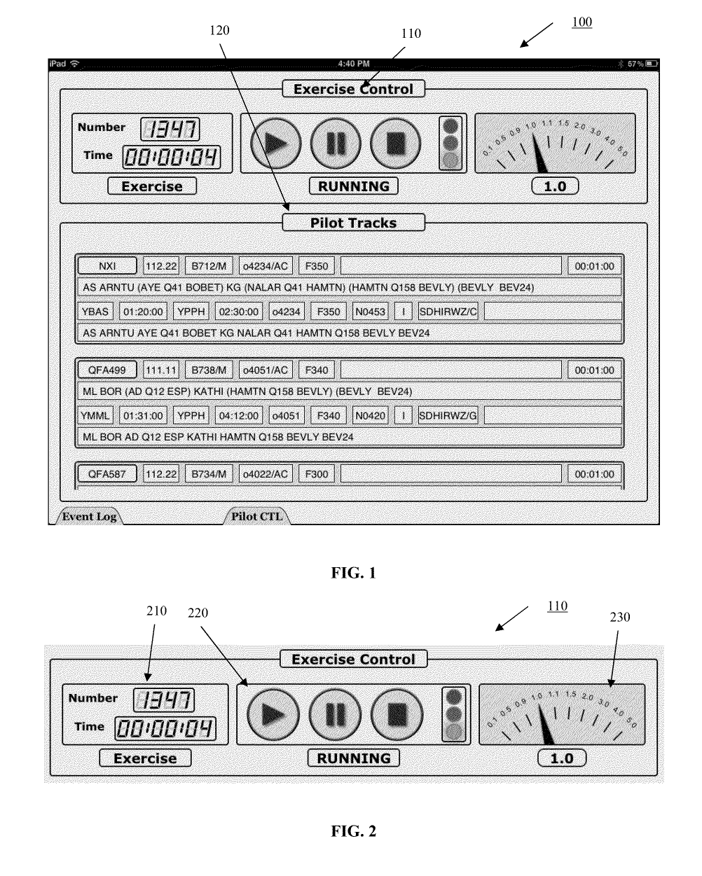

The portable device connects to the ATC training system via a wireless network connection and interchanges data and control messages with this system. The training supervisor is able to view and interact with this through a Simulator Control Display 110 shown in FIG. 1, although the entire tablet computing device is not shown for ease of illustration only. The Simulator Control Display 100 comprises an Exercise Control Panel 110 and a Pilot Tracks Panel 120. In this embodiment, the Simulator Control Display 100 has the Exercise Control Panel 110 positioned above the Pilot Tracks Panel 120. Isolated views of the Exercise Control Panel 110 and the Pilot Tracks Panel 120 are provided in FIGS. 2 and 6, respectively.

Referring to FIG. 2, the Exercise Control Panel 110 displays the following:
Exercise Information panel 210 is located to the left of the screen,
Exercise Status panel 220 is located in the centre, and
Exercise Speed panel 230 is located on the right.

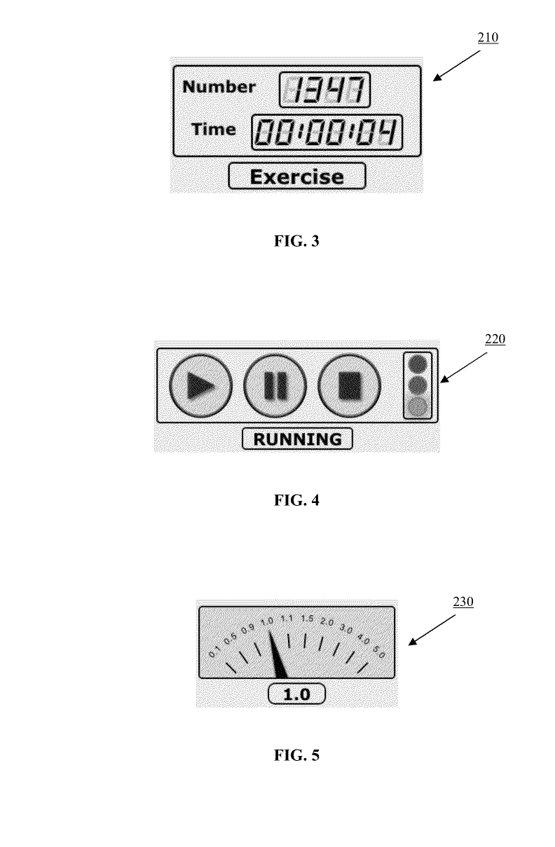

As shown in FIG. 3, the Exercise Information panel 210 displays the currently running Exercise number and the current Exercise Time. This panel 210 is not interactive. The Exercise Information panel 210 displays Exercise Number 1347 and time 00:00:04 for this Exercise.

As shown in FIG. 4, the Exercise Status Panel 220 allows for the displaying of the ATC training exercise state and for the modification of this state by user input. The panel 220 displays the current exercise state at the bottom in this embodiment (e.g., RUNNING in FIG. 4), which can be RUNNING, PAUSED, or STOPPED. On the right of this panel is a traffic light indicator to provide a quick indication of what the state is. Green is RUNNING, Orange is PAUSED, and red is STOPPED. In the centre of the control panel 220 are three buttons: a Play button, a Pause button, and a Stop button. These buttons are for: pausing the exercise, stopping the exercise, and resuming the exercise. The user can press these buttons, by tapping a finger on a displayed button, which causes the tablet computing device to send a message wirelessly to the ATC training system to perform these actions. If these actions are successful, the State is updated in the “Exercise State” field and reflected in the traffic light indicators. If the exercise is stopped or paused, the Exercise time also stops updating.

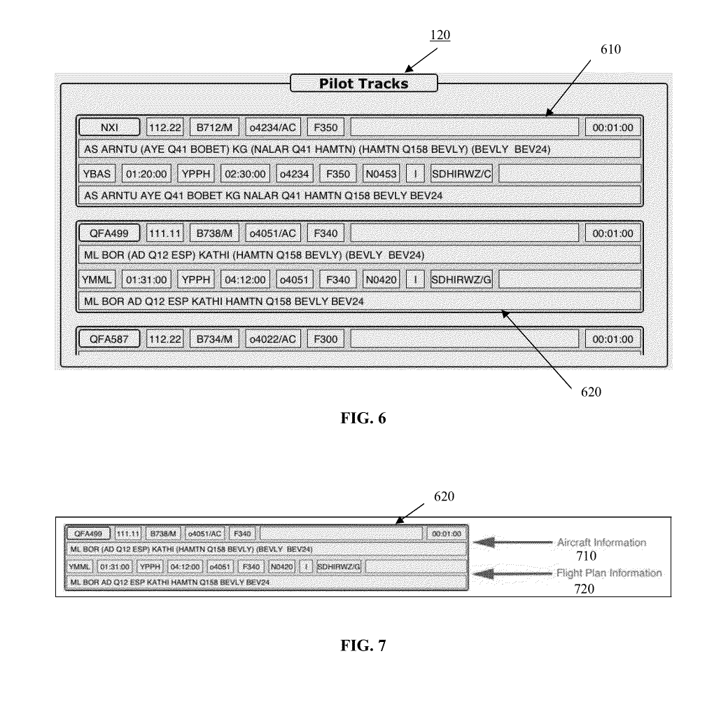

Referring to FIG. 5, the Exercise Speed Panel is an interactive panel used to control and display the current ATC training exercise speed. The user may select the pointer with their finger to modify the speed and drag the pointer to point to the desired speed. Lifting the finger off the screen causes the tablet computing device or other suitable portable electronic device to send wirelessly the new desired exercise speed to the ATC training system. If the user lifts their finger from the display when the pointer is between two speed settings, the pointer may move to the closest speed. The Exercise Speed pane 230 has an analog and digital display of the rate of the exercise. For example, the speed 1.0 indicates normal speed. A speed of 0.1 would indicate a slow speed for the exercise, and the speed 5.0 would indicate a high speed. The Exercise Status and Exercise Speed panes 220, 230 allow an instructor to provide inputs to the training simulator.

In FIG. 1, below the Exercise Control Panel 110 is the Pilot Tracks panel 120, shown in isolation in FIG. 6. This panel 120 is an interactive list panel that displays details of one or more simulated aircraft in the currently executing training exercise that are due to become active. Each aircraft is displayed as a block of data or strip 610, 620 and are sorted in the order of exercise activation time. At the top are those aircraft that will be activated next. The second strip 620 is shown in isolation in FIG. 7.

Each aircraft strip 610, 620 is split into two areas. As shown in FIG. 7, the top two rows of the strip (e.g., 620) display elementary aircraft information 710, including:
Aircraft callsign,
Assigned radio frequency,
Aircraft type and wake turbulence category,
Aircraft transponder code (SSR code) and mode,
Aircraft flight level,
Aircraft activation time, and
Aircraft planned route.

Below the elementary aircraft information 710 is information that will be contained in the flight plan 720 submitted to the ATC training system by the simulator and includes:
Destination Airport,
Estimated time of departure,
Departure Airport,
Estimated Entry Time,
Aircraft transponder code,
Cleared flight level,
Cleared speed,
Flight rules,
Aircraft equipment,
Controller comments, and
Planned flight route.

Aircraft planned route and planned flight route may differ.

To display more than the first two strips 610, 620 in FIG. 6 the user presses their finger on the screen and swipes their finger up the screen. This causes the strips to scroll up the screen (from bottom to top) to reveal more strips below. The user can also swipe down to scroll back to the top of the list.

As the Exercise time reaches the activation time of each aircraft, the associated strip 610, 620 is removed from this list.

### Processing on Portable Device

A number of processes utilised by a portable device in accordance with an embodiment of the invention are described hereinafter in greater detail. The processes enable the portable device to manage and control the operation of one or more training exercises in an Air Traffic Control (ATC) training system. The portable tablet device connects wirelessly to an ATC simulation group in the training system. The portable tablet device provides tactical tools to assist the execution of the exercise and evaluation of the student.

As shown in FIG. 8, the portable tablet device 810 can be connected to, or disconnected from, any one of N ATC simulation groups. In the example shown in FIG. 8, the tablet device 810 is wirelessly connected to the simulation group 810 and is disconnected from the simulation group 820. FIG. 9 illustrates the states and overall operation of the portable tablet device 810 to control operation of a training exercise. The portable tablet device may be in a disconnected 910 or connected 920 state or mode and can transition from either mode to the other relative to a simulation group. So, from the disconnected mode 910, the portable tablet device may connect to a simulation group and enter the connected state or mode 920. Likewise, from the connected mode 920, the portable tablet device may disconnect from a simulation group and enter the disconnected mode 910. In the connected mode 920, session data 930 may be written to a storage device of the portable tablet device. In the disconnected mode 910, the session data 930 may be read by the portable tablet device. In the disconnected state 910, the device 810 provides offline functions, e.g. access to the data 930 from previous sessions. In the connected state 920, the device 810 provides online functions, e.g. interact with the training exercise and display data of the exercise in real time.

The data exchange between the portable device 810, of FIG. 8 and the simulation group 810, 820 follows the client/server pattern. The device (client) 910 connects to the simulation group (server) 820, 830 on demand. Only one device 810 may be connected to a simulation group 820, 830 at any given time.

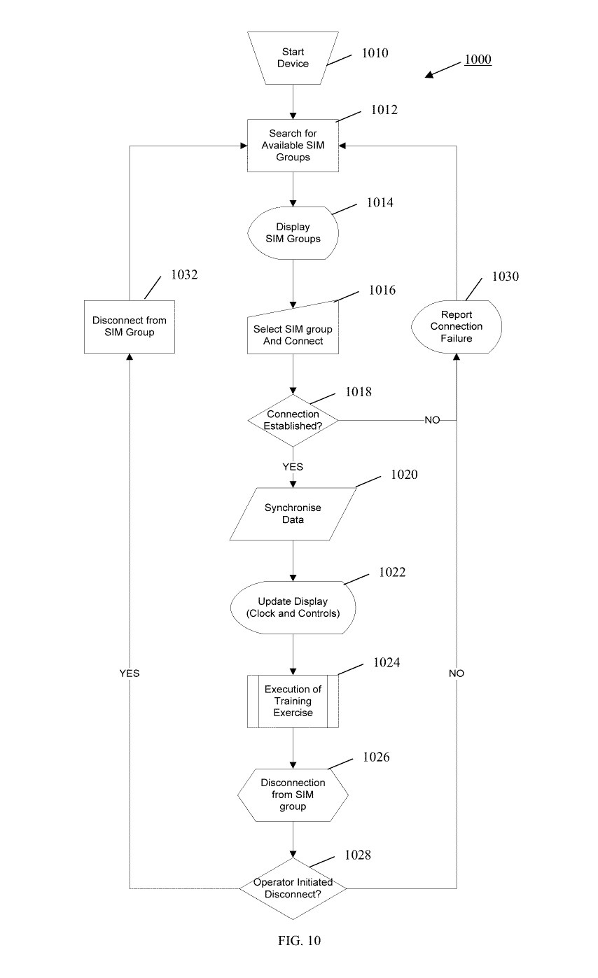

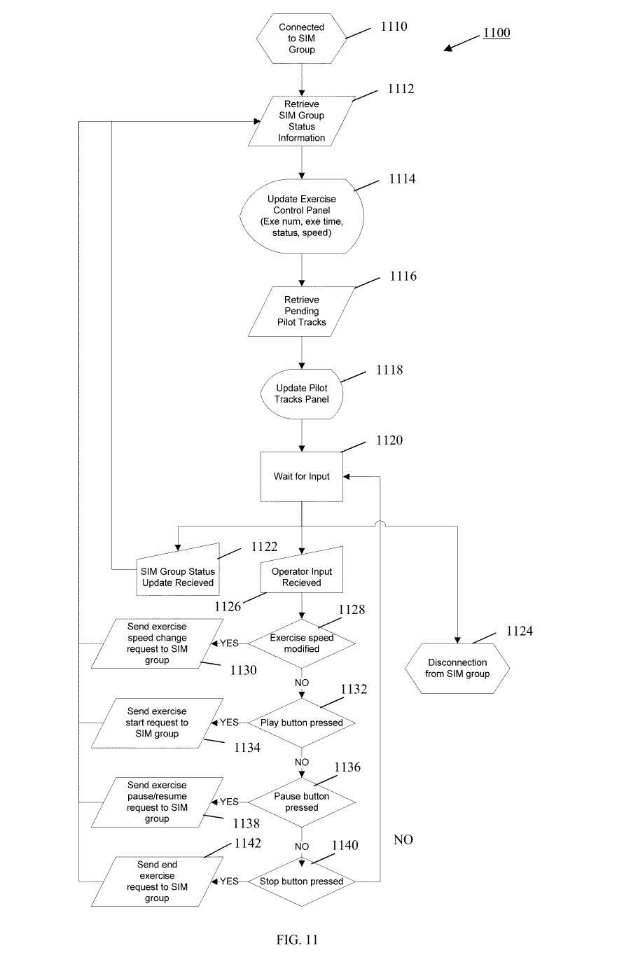

FIG. 10 illustrates a connection management process 1000. In step 1010, the portable tablet device 810 is started. In step 1012, a search is performed by the device 810 for available SIM (simulation) groups 820, 830. In step 1014, any simulation groups that were found in the search are displayed on the device 810. In step 1016, an operator (e.g., an instructor) can select a SIM group and wirelessly connect to the SIM group. The operator may provide inputs to the tablet to do this. In decision step 1018, a check is made by the device to determine if a connection was established. If step 1018 returns false (NO), processing continues at step 1030. In step 1030, the device 810 reports a connection failure and processing continues at step 1012 to search for available SIM groups. Otherwise, if decision step 1018 returns true (YES), processing continues at step 1020.

In step 1020, data is synchronised between the device 810 and the data store 826, 836 of the connected SIM group. This may be done by wireless communications transmitting data regarding the training exercise to the tablet device 810 from the simulator, and vice versa. In step 1022, the display (including clock and controls) on the device 810 is updated. For example, the Simulator Control Display 100 of FIG. 1 is updated, including updating the Exercise Control Panel 110 and the Pilot Tracks Panel 120. In step 1024, the training exercise is executed and the device 810 remains in the connected state. At some point, disconnection from the connected SIM group occurs in step 1026. The device is now in the disconnected state. The portable device 810 performs a decision step 1028 in which a check is made of whether the operator initiated the disconnect. If decision step 1028 returns false (NO), processing continues at step 1030. Otherwise, if decision step 1028 returns true (YES), processing continues at step 1032. In step 1032, the portable device disconnects from the SIM group. Processing then continues at step 1012.

FIG. 11 illustrates a process 1100 of controlling training exercises using the device 810 through the exchange of messages (e.g., using wireless communications) between the portable device 810 and the attached simulation group 820, 830 in FIG. 8. In step 1110, the portable device 810 is connected to a SIM group 820, 830. In step 1112, the device 810 retrieves status information of the SIM group from the data store 826, 836. In step 1114, the Exercise Control Panel is updated and displayed on the portable device 810. The Exercise Number, Exercise Time, Status, and Speed, for example, may be updated. In step 1116, the pending Pilot Tracks are retrieved by the device 810 from the simulator. The Pilot Tracks Panel 120 of FIG. 1 or 6 is updated. The device 810 then enters a state of waiting from an input of the operator using the input mechanism (e.g., the touchscreen of a tablet device). From step 1120 processing can continue at any one of steps 1122, 1124, and 1126.

In step 1122, the device 810 receives a SIM group status update, and processing continues at step 1112.

In step 1124, the device 810 enters a disconnection state from the SIM group.

In step 1126, an operator input is received by the device 810. In decision step 1128, a check is made to determine if the exercise speed has been modified, e.g. using Exercise Speed Panel 230 displayed on the device 810. If decision step 1128 returns true (YES), processing continues at step 1130. In step 1130, the device 810 sends an exercise speed change request to the SIM group. Processing then continues at step 1112. If decision step 1128 returns false (NO), processing then continues at step 1132. In decision step 1132, a check is made to determine if the Play button has been pressed, e.g. using the Exercise Status panel 220 displayed on the device 810. If decision step 1132 returns true (YES), processing continues at step 1134. In step 1134, the device 810 sends an exercise start request to the SIM group. Processing then continues at step 1112. If decision step 1132 returns false (NO), processing continues at step 1136. In decision step 1136, a check is made to determine if the Pause button has been pressed, e.g. using the Exercise Status panel 220 displayed on the device 810. If decision step 1136 returns true (YES), processing continues at step 1138. In step 1138, the device 810 sends an exercise pause/resume request to the SIM group. Processing then continues at step 1112. If decision step 1138 returns false (NO), processing continues at step 1140.

In decision step 1140, a check is made to determine if the Stop button has been pressed, e.g. using the Exercise Status panel 220 displayed on the device 810. If decision step 1140 returns true (YES), processing continues at step 1142. In step 1142, the device 810 sends an exercise end request to the SIM group. Processing then continues at step 1112. If decision step 1140 returns false (NO), processing continues at step 1120.

### Portable Electronic Device Capable of Wireless Communications

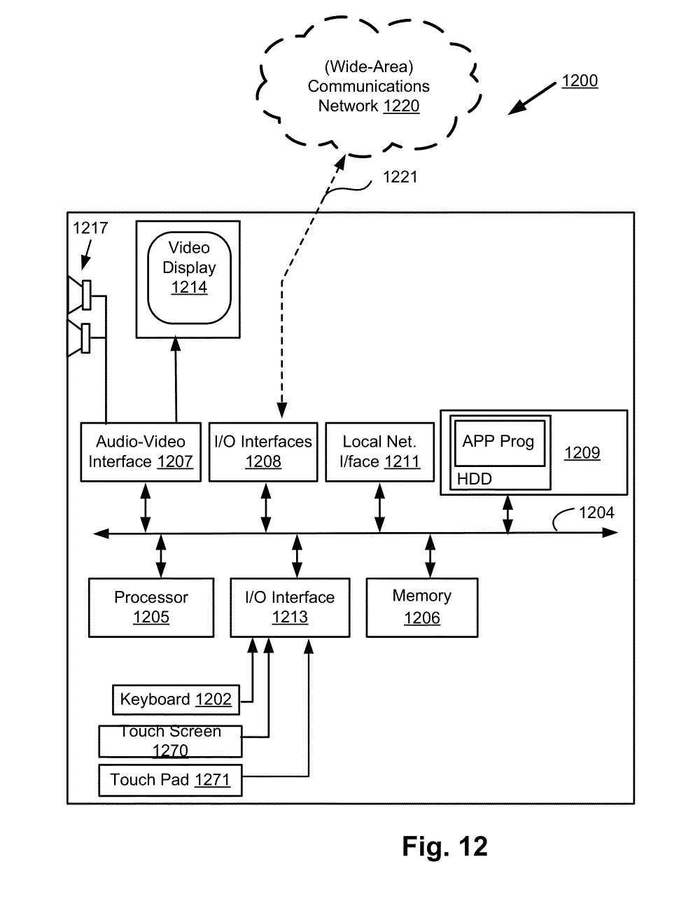

FIG. 12 is a block diagram of handheld portable electronic device 1200, such as a tablet computing device like the Apple™ iPad™, with which embodiments of the invention may be practiced.

As seen in FIG. 12, the device 1200 includes: a processor 1205, input devices (such as a keyboard 1202, a touchscreen 1270, and a touchpad 1271), output devices (such as a display device 1214 and audio/video output; speakers 1217 are optional). A wireless interface 1208, such as WiFi, allows wirelessly communicating 1221 to and from a communications network 1220. The communications network 1220 may be a wide-area network (WAN), such as the Internet, a cellular telecommunications network, or a private WAN.

Preferably, the video display 1214, a touchscreen 1270, processor 1205, etc are all contained in the same physical container or housing, e.g. as would the case of a tablet computing device. The processor 1205 is coupled to a memory unit 1206, which may be semiconductor random access memory (RAM) and semiconductor read only memory (ROM). An audio-video interface 1207 couples the other device components to the video display 1214, and optional speakers 12 17. An I/O interface 113 can be coupled to the keyboard 1202, the touchscreen 1270, and touchpad 1271, and optionally any other human interface device (not illustrated). The computer module 1200 may have a local network interface 1211, which permits coupling of another communications network, such as a Local Area Network (LAN). The local network interface 1211 may comprise an Ethernet™ circuit card or a Bluetooth™ wireless arrangement; however, numerous other types of interfaces may be practiced for the interface 1211.

The I/O interfaces 1208 and 1213 may afford either or both of serial and parallel connectivity, the former typically being implemented according to the Universal Serial Bus (USB) standards and having corresponding USB connectors (not illustrated). Storage devices 1209 are provided and typically include a hard disk drive (HDD). Other storage devices may also be used. Portable memory devices, such optical disks (e.g., CD-ROM, DVD, Blu ray Disc™), USB-RAM, portable, external hard drives, and floppy disks, for example, may be used as appropriate sources of data to the system 1200.

The components 1205 to 1213 of the device 1200 typically communicate via an interconnected bus 1204 and in a manner that results in a conventional mode of operation of the computer system 1200 known to those in the relevant art. For example, the processor 1205 is coupled to the system bus 1204. Likewise, the memory 1206 is coupled to the system bus 1204.

The method using portable handheld devices for controlling a training exercise running on an ATC system may be implemented as one or more software application programs executable on the processor 1205. In particular, the steps of the method may be effected by instructions in the software that are carried out within the device 1200. The software instructions may be formed as one or more computer program code modules, each for performing one or more particular tasks. The software may also be divided into two separate parts, in which a first part and the corresponding code modules performs the image arranging methods and a second part and the corresponding code modules manage a user interface between the first part and the user.

The software may be stored in a computer readable medium. The software is loaded into the processor from the computer readable medium, and then executed. A computer readable medium having such software or computer program recorded on the computer readable medium is a computer program product. The use of the computer program product in the device preferably effects an advantageous apparatus for controlling a training exercise running on an ATC system.

In some instances, the application programs may be supplied to the user encoded on one or more CD-ROMs and read via a corresponding drive, or alternatively may be read by the user from the network 1220. Still further, the software can also be loaded into the device 1200 from other computer readable media. Computer readable storage media refers to any storage medium that provides recorded instructions and/or data.

The second part of the application programs and the corresponding code modules mentioned above may be executed to implement one or more graphical user interfaces (GUIs) to be rendered or otherwise represented upon the display 1214. The display 1214 is preferably comprised of a touchscreen 1270, where a finger may be used to manipulate the interface to provide controlling commands and/or input to the software applications associated with the GUI(s). In this instance, the device 1200 may not require the keyboard 1202.

The arrangements described are applicable to the ATC systems and in particular training systems for such ATC systems.

Methods using portable handheld devices and such devices themselves adapted for controlling a training exercise running on an ATC system have been described. The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. An open ended meaning is contemplated, instead of a close-ended expression such as “consisting of”. Variations of the word “comprising”, such as “comprise” and “comprises” have correspondingly varied meanings.

1. A portable electronic device for controlling an Air Traffic Control (ATC) training exercise executing in an ATC training system comprising an ATC system connected to an ATC simulator, said device comprising:
a wireless communications interface for wirelessly communicating with said ATC training system adapted for wireless communications;
a display;
a memory for storing data and one or more computer programs;
a user input mechanism for receiving inputs;
a processor coupled to said memory, said user input mechanism, said display, and said wireless communications interface, said processor executing computer program code for:
displaying on said display information about an ATC training exercise executing on said ATC simulator of said ATC training system; and
receiving inputs of an ATC instructor to control said ATC training exercise on said ATC simulator, said displayed information and said received inputs being wirelessly communicated between said portable electronic device and said ATC training system.

2. The portable electronic device as claimed in claim 1, being implemented in a tablet computing device a touchscreen that implements said display and said user input mechanism.

3. The portable electronic device as claimed in claim 1, wherein said computer program executing on said processor provides a Simulator Control Display displayed on said display, said Simulator Control Display comprising an Exercise Control Panel and a Pilot Tracks Panel.

4. The portable electronic device as claimed in claim 1, further comprising computer program code executing on said processor to provide graphical objects displayed on said display for controlling operation of said ATC training exercise on said ATC simulator of said ATC training system, including RUNNING, PAUSING, and STOPPING commands, in response to a user input received by the user input mechanism.

5. The portable electronic device as claimed in claim 1, further comprising computer program code executing on said processor to provide a graphical object for displaying and adjusting the speed at which said ATC training exercise is carried out on said ATC simulator of said ATC training system.

6. The portable electronic device as claimed in claim 1, further comprising computer program code executing on said processor to provide pilot track strips displayed on said display, including aircraft information and flight plan information.

7. A method of controlling an Air Traffic Control (ATC) training exercise executing in an ATC training system comprising an ATC system connected to an ATC simulator, said method comprising:
displaying on a display of said portable electronic device information about an ATC training exercise executing on said ATC simulator of said ATC training system;
receiving inputs of an ATC instructor using said portable electronic device to control said ATC training exercise on said ATC simulator of said ATC training system; and
wirelessly communicating said displayed information and said received inputs between said portable electronic device and said ATC training system.

8. The method as claimed in claim 7, wherein said portable electronic device comprises a wireless communications interface for wirelessly communicating with said ATC training system adapted for wireless communications, a memory for storing data and one or more computer programs, a user input mechanism for receiving inputs, and a processor coupled to said memory, said user input mechanism, said display, and said wireless communications interface, said processor executing computer program code for displaying on said display information an ATC training exercise executing on said ATC simulator of said ATC training system and for receiving inputs to control said ATC training exercise on said ATC simulator of said ATC training system, said displayed information and said received inputs being communicated between said portable electronic device and said ATC training system.

9. The method as claimed in claim 7, wherein said portable electronic device comprises a tablet computing device a touchscreen that implements said display and said user input mechanism.

10. The method as claimed in claim 7, comprising displaying a Simulator Control Display on said display, said Simulator Control Display comprising an Exercise Control Panel and a Pilot Tracks Panel.

11. The method as claimed in claim 7, comprising providing graphical objects displayed on said display for controlling operation of said ATC training exercise on said ATC simulator of said ATC training system, including RUNNING, PAUSING, and STOPPING commands, in response to a user input received by the user input mechanism.

12. The method as claimed in claim 7, comprising providing a graphical object for displaying and adjusting the speed at which said ATC training exercise is carried out on said ATC simulator of said ATC training system.

13. The method as claimed in claim 7, comprising providing pilot track strips displayed on said display, including aircraft information and flight plan information.

14. A computer program product comprising a computer readable medium having recorded thereon a computer program for controlling an Air Traffic Control (ATC) training exercise executing in an ATC training system comprising an ATC system connected to an ATC simulator, said computer program product comprising:
computer program code means for displaying on a display of said portable electronic device information about an ATC training exercise executing on said ATC simulator of said ATC training system;
computer program code means for receiving inputs of an ATC instructor using said portable electronic device to control said ATC training exercise on said ATC simulator of said ATC training system; and
computer program code means for wirelessly communicating said displayed information and said received inputs between said portable electronic device and said ATC training system.

15. The computer program product as claimed in claim 14, wherein said portable electronic device comprises a wireless communications interface for wirelessly communicating with said ATC training system adapted for wireless communications, a memory for storing data and one or more computer programs, a user input mechanism for receiving inputs, and a processor coupled to said memory, said user input mechanism, said display, and said wireless communications interface, said processor executing said computer program code means for displaying on said display information an ATC training exercise executing on said ATC simulator of said ATC training system and said computer program code means for receiving inputs to control said ATC training exercise on said ATC simulator of said ATC training system, said displayed information and said received inputs being communicated between said portable electronic device and said ATC training system.

16. The computer program product as claimed in claim 14, wherein said portable electronic device comprises a tablet computing device a touchscreen that implements said display and said user input mechanism.

17. The computer program product as claimed in claim 14, comprising computer program code means for displaying a Simulator Control Display on said display, said Simulator Control Display comprising an Exercise Control Panel and a Pilot Tracks Panel.

18. The computer program product as claimed in claim 14, comprising computer program code means for providing graphical objects displayed on said display for controlling operation of said ATC training exercise on said ATC simulator of said ATC training system, including RUNNING, PAUSING, and STOPPING commands, in response to a user input received by the user input mechanism.

19. The computer program product as claimed in claim 14, comprising computer program code means for providing a graphical object for displaying and adjusting the speed at which said ATC training exercise is carried out on said ATC simulator of said ATC training system.

20. The computer program product as claimed in claim 14, comprising computer program code means for providing pilot track strips displayed on said display, including aircraft information and flight plan information.

21. An air traffic control (ATC) training system, comprising:
an ATC simulator for performing an ATC training exercise involving one or more simulated aircraft;
an ATC system connected to said ATC simulator; and
a portable electronic device as claimed in claim 1 for controlling an ATC training exercise executing on said ATC simulator of said ATC training system.
